(19) United States
(12) Patent Application Publication
(10) Pub. No.: US 2003/0120437 A1
(43) Pub. Date: Jun. 26, 2003

(54) Method and apparatus for on-line monitoring of solid-fuel/air flows

(76) Inventor: Yaosheng Chen, Blacksburg, VA (US)

Correspondence Address: Yaosheng Chen, 200 Country Club Drive Bldg D, Blacksburg, VA, 24060, US

(21) Appl. No.: 10/032,165

(22) Filed: Dec. 21, 2001

(51) Int. Cl. G01F 7/00

(52) U.S. Cl. 702/45

(57) ABSTRACT

A method and apparatus for on-line monitoring of solid-fuel/air rate of flows in a pipe as in a boiler or during gasification processes with high accuracy, high reliability, and a fast response are disclosed. The apparatus essentially comprises optical fiber vibration sensors, a spherical ejector rod, and a signal-emitting device installed in a housing, inside a pipe, to determine solid-fuel/air ratios and their rate of flow simultaneously. In terms of a master controller and a group of on-line controllers, monitoring the intake of granular carbonaceous material such as water vapor and air approaches the optimal operating status by regulating the temperature of the boiler or used in the gasification process, in accordance with the comparison of the data detected by current methods and optimal data.

### FIELD OF INVENTION

The present invention relates to the optics-electronics field and coal gasification techniques in general. Specifically, the present invention correlates to a device utilized in boilers and gasification processes at thermal power plants. This design satisfies harsh conditions and substances endowed in pipelines. Flour, cement, and sand are such examples. On-line monitoring allows the user to identify the ratio of solid-fuel/air and the rate of flow simultaneously.

### BACKGROUND

Rigid testing requirements were placed on the control of solid-fuel/air ratio and the rate of flow, after the profound developments in gasification technology. Currently in thermal power plants, coal slurry is first heated at a range of temperatures varying from 100° C. to 300° C., then it is sprayed into a burner by the force of a compressed air jet, while being fed through a pipeline. Meanwhile, many elements are being dispersed during this process. Referring to granular carbonaceous material, notable measures of water vapor, oxygen, and lastly air. The above-mentioned multiphase flow, prevailing in use, constrains proper figures from being interpreted through an on-line database. The present invention is designed to convey concise representation of an on-line observation in regards to solid-fuel/air ratio and the rate of flow.

During the provisions process, air egress is deliberated more swiftly than known traditional methods acquired through mixing processes. Assumed, air egress is a result of the rate of airflow. Slurry or parched materials, which enter through the provisions process, could be identified in the mixture process between water vapor and carbonaceous matter. Under the assumption that coal slurry can be doubly classified not only as a finely divided substance, but also as a solid mass, the present invention clearly proves its method and apparatus as a solid idea.

The apparatus at hand can be constructed in the interior of pipelines, via a network of connected flange, which eliminates interference from environmental conditions that exist in the atmosphere above ground including temperature and noise pollution. By analyzing solid-fuel/air ratios at their peak optimum performance levels, energy conservation will be rewarded and efficiency will be afforded towards immense boilers and gasification processes. Furthermore, coal classification will be revealed throughout different production stages and will aid in data collection towards the on-line monitoring system. The inventor, currently possess a patent to monitor fuel combustion rates (U.S. Pat. No. 6,042,365), which authenticates the research as not only being worthwhile, and meaningful, but nonetheless provides the technology world with powerful insights and ideas.

### SUMMARY OF THE INVENTION

Many separable elements are intertwined to befit the present invention. As stated before, the main recipients to benefit from this present invention are massive boilers and gasification processes that are not currently capable of being energy efficient. The following logic is used to supply documentation to determine that the present invention is true and genuine. Optical fibers house a vibration sensor that will detect V, the flow rate of air/solid mixtures. P, which refers to the pipeline's interior wall pressure, is to be measured by piezo. Granted, P, can be adapted as the equivalent to represent the following: density, ρ, equals the rate of flow in unit time, and volume, where ρ designates the air/fuel ratio. Quantitative calculation instruments are arranged proportionally in the heating and vaporization processes. Speculated on the supplied facts above, on-line monitoring can furnish adequate determinations in regards to the rate of airflow and output.

### BRIEF DESCRIPTION OF THE DRAWINGS

FIG. 1 provides an intimate customary constructed drawing; the chart on page 4 refers to the coordinating numerals on the drawing.

FIG. 2 is a schematic diagram of the mechanisms and output from the optical fiber vibration and pressure sensors.

### REFERENCE NUMERALS IN DRAWING

1. Pipe That Is To Be Measured

2. Flange

3. Spherical Ejector Rod

4. Fender

5. Sylphon

6. Compressing spring

7. Retainer

8. Heat Preservation Chamber

9. Optical Fiber Vibration Sensor

10. Spring

11. Piezo

12. Signal Emitting Device

13. Optical Fiber Cable Connector Head

14. Housing

15. Special Cable

16. On-line controller

17. Computer

18. Recorder

19. Operating Mechanism

### DETAILED DESCRIPTION

The present invention is an apparatus specifically designed for on-line monitoring of solid-fuel/air ratio and their rate of flow. As previously mentioned, the main focus will be thermal power plants. Presently, coal is crushed into fine granules that measure under φ1 mm in size. Following heating and vaporization processes, a stream of compressed air disperses the coal powder into the boiler. One of the many benefits, for example, is easy installation. Second, on-line monitoring follows the modem technology age of computers by providing a detailed and accurate reading of solid-fuel/air ratio and their rate of flow. Modifying the quality of air output, vaporization techniques, and the rate of flow for solid fuel, will lead to optimal control for combustion and gasification processes.

The inventor applied previous knowledge based on an approved patent (U.S. Pat. No. 6,042,365), which discovered the combustion parameters inside a burner. Decided that the optimal output will be obtained, the following formula can be assumed as a statistical calculation to further acknowledge that solid-fuel/air ratio and their rate of flow are fixed.

$$ρ = \frac{2 ( c - p )}{{V}^{2}} \qquad ( 1 )$$

Where P equals the pressure of the pipe wall pressure, V equals the rate of flow, ρ equals the solid-fuel/air ratio, and C remains a constant that can be obtained by calibration.

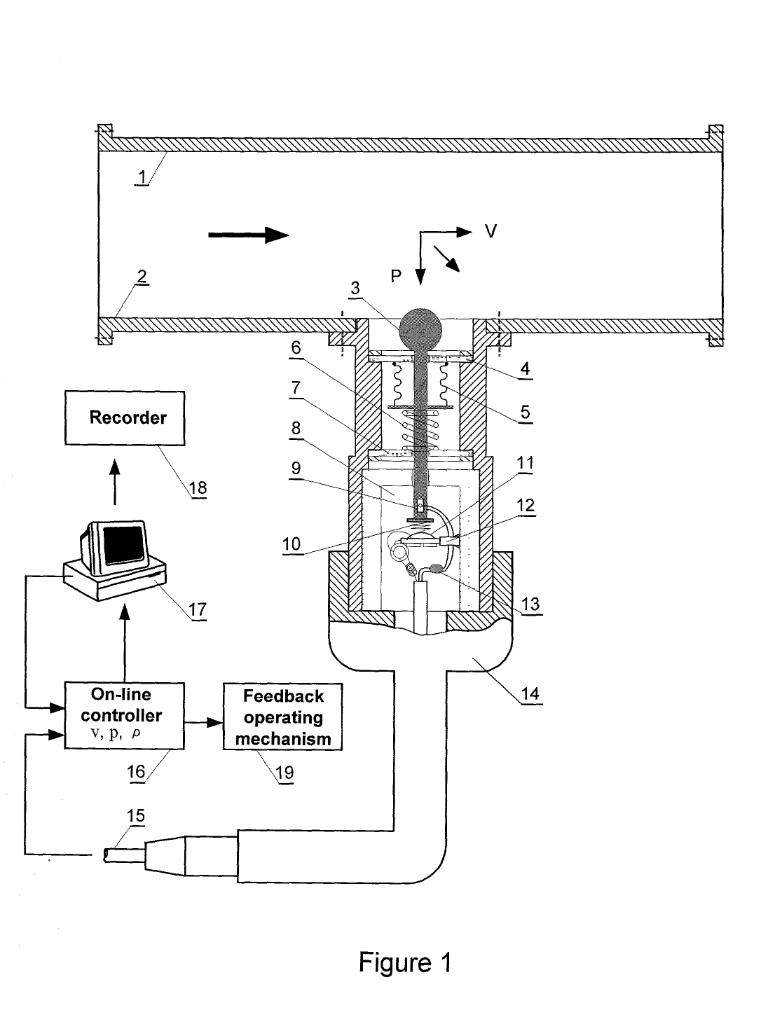

The optimal control constantly varies due to many contributing factors such as the quality of the coal and random heating temperatures. Due to this ever-changing status, the input also varies accordingly, resulting in a brief stabilization period. The present invention will resolve this dilemma. The following is a quick introduction on how the present invention will operate. Refer to FIG. 1; connect the undetermined pipe 1 by flange 2 halfway inside the pipeline. The inner diameter of the pipe 1 is around 12 inches, which matches the diameter of the pipeline. As the flow progresses through the pipe 1, the two forces are applied to the spherical ejector rod 3; V (horizontal in direction) and P (perpendicular in direction). The spherical ejector rod 3 and the sylphon 5, are molded by the assistance of the fender 4, granular coal is trapped outside. The percussion beneath the greatest rate of flow will force pressure against the retainer 7 and the spring 6, which assist the sphere in maintaining particular parameter limits. Together the force from V and P will jack up the spring 10, the LED will be lit by piezo 11, digital signals of pressure will be output, and the rate of flow will be transmitted to the vibration sensor 9. Assumed that as the solid mass rate of flow increases, P will increase as well, V will decrease. If the solid mass rate of flow decreases the opposite will happen. The sensors, 9 and 11, along with the signal-emitting device 12, are joined together by the optical fiber connector head 13 located in the heat preservation chamber 8. The special cable 15 is lead out through the housing 14.

Once V and P are known, the solid-fuel/air ratio can be calculated. Since the value of C was calibrated before using, the density ρ is extrapolated by formula (1). In this case, ρ represents the solid mass in a particular volume of compressed air. Knowing the parameters, V, rate of flow, and water vapor rate of flow, the computer can send feedback signals to adjust the solid-fuel/air ratio, which in turn maintains the optimal control status. Furthermore, an intelligent control net is set.

The subsequent summarizes FIG. 1 in greater detail. The sensors are built in the housing 14, connected to the pipe 1 by bolts. The special fiber optical cable 15 links the on-line controller, which provides signals to the computer 17. Next, the on-line controller 16 adjusts the operating mechanism 19, in turn associates feedback data. In a short time period of forty-eight hours, every parameter can be monitored. The recorder 18 would track the data automatically. Therefore, the information can be on hand twenty-four hours a day if necessary.

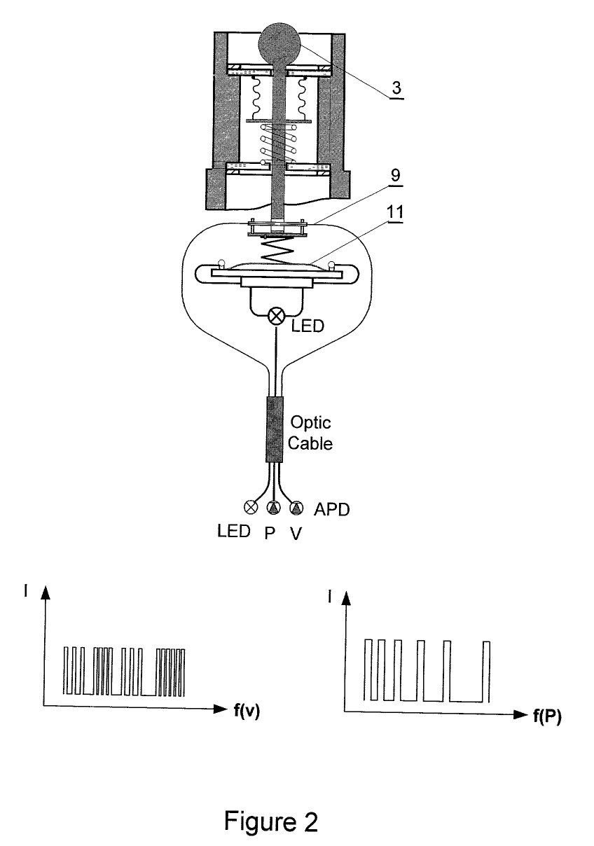

FIG. 2 provides an in-depth view of the optical fiber vibration and pressure sensors. This diagram demonstrates the frequency change of impulse in a series, where the values of V and P are represented. In the present invention, a diaphragm can replace the sylphon 6. The rod 3 can be weld to the diaphragm, together becomes one part 4. In this case, part 6 can be removed.

When additional force is introduced to the sphere, the diaphragm bends and deforms. For a periphery diaphragm, the bending deflection in the central area is calculated by the following formula.

$$w = \frac{3 ( 1 - {μ}^{2} ) {a}^{4} P}{16 E {τ}^{3}} \qquad ( 2 )$$

Where τ represents the thickness of the diaphragm; E represents elastic modulus; μ represents Poisson's ratio; P represents pressure; a represents the effective radius of the diaphragm; and w represents the bending deflection of the central area. The formula above displays the displacement of a diaphragm in proportion to the pressure P.

The present invention is suitable for dynamic measures, where frequency plays an important role. When the periphery of a diaphragm is fixed, the lowest natural frequency can be found by using the formula below.

$${f}_{0} = \frac{2.56 τ}{π {a}^{2}} \sqrt{\frac{8 d}{3 P ( 1 - {μ}^{2} )}} \qquad ( 3 )$$

Where q represents the acceleration of gravity and d represents the density of the diaphragm material.

The material of the diaphragm can be composed of either stainless steel or phosphor bronze; the thickness τ estimates around a range of 0.2-0.6 mm. When the thickness increases, the percussion of the flow to the sphere can be classified as a small load. Test results indicate that, less than 1 μm displacement, a dramatic change results from the amplitude of the impulse series, which falls into a range of 2-10 mV.

Once the output signals from the sensors pass through the circuit, digital signals transform into V and P after pulse shaping, this allows a smoother connection with the computer. The solid-fuel/air flows through the pipelines, causing the spherical ejector rod to vibrate, the transmission is sent to the sensor 9, where vibration signals convert to an optical impulse series. The frequency outcome of the series portrays the rate of flow. During this transition, the additional force to the sphere reacts by sending signals to piezo, in turn displays LED light, which bestows optical impulse signals associated with pressure. The corresponding pressure signals are transmitted by optical fiber.

In general, the average temperature is around 300° C. Therefore, the key components and optical fiber sensors should be assembled in a heatproof compartment. The core/cladding diameter of the optical fiber is 200 μm/300 μm, and piezo located in the pressure sensor is PZT; both components are commercially available.

What is claimed is:

1. The present invention is both a method and an apparatus for the purpose of solid-fuel/air rate of flow, which detects the solid-fuel/air ratio. In practice, will measure the coal slurry and air ratio. The present invention consists of a pipe to be measured, sensors, an on-line controller, and a compute that can effectively achieve adjustments for not only solid-fuel value, but also air and water vapors. The outcome achieved will be the monitoring of the optimal efficiency status.

2. The apparatus in claim 1, involves the key component of the spherical ejector rod that is located in the pipe 1. Not only can the rod block granular coal, but it can also restrain from having any additional influence on the flow. Both forces together, V (horizontal in direction) and P (perpendicular in direction), can be easily obtained by the sphere. The optical vibration sensor and the piezo pressure sensor, together, applied towards the sphere, can detect the forces V and P. Afterwards; the data is transmitted to the computer.

3. The computer can transform the signals in claim 2, as stated. Accordingly, the cable length should be set to satisfy any requirements. Generally, the cable length averages around five meters, measuring from the sensors to the on-line controller. Every nozzle will have installed, a solid-fuel/air ratio-testing device. Any output signals will flow through the controller. In summary, cables will connect the computer (master controller), data will be recorded, and then automatically feedback is presented to the operating mechanism.

4. The apparatus, described in claim 3, adopts optical fiber cable bus techniques instead of the traditional master controller or the on-line controller. In various cases, the cable can measure from hundreds of meters to 1 km.

5. The present invention, therefore, as in claim 4, is identified as a digital fiber sensor, and connects easily to most computers.
